(19) United States
(12) Patent Application Publication
(10) Pub. No.: US 2024/0405242 A1
(43) Pub. Date: Dec. 5, 2024

(54) ELECTRICITY PRODUCTION FACILITY COMPRISING A FUEL CELL AND A CHEMICAL REACTOR AND ASSOCIATED PROCESS

(71) Applicant: Bruno Sanglé-Ferrière, PARIS (FR)

(72) Inventor: Bruno Sanglé-Ferrière, PARIS (FR)

(21) Appl. No.: 18/800,099

(22) Filed: Aug. 11, 2024

Related U.S. Application Data
(63) Continuation-in-part of application No. 17/869,459, filed on Jul. 20, 2022.

(30) Foreign Application Priority Data
Jul. 21, 2021 (FR) FR2107884
Oct. 13, 2023 (FR) FR2311050

(51) Int. Cl. H01M 8/065; C25B 1/27; H01M 8/04082

(52) U.S. Cl. CPC H01M 8/065; C25B 1/27; H01M 8/04201

(57) ABSTRACT

The present invention provides a facility for producing electricity comprising a non-galvanic fuel cell whose heat is recovered for implementing endothermic chemical reactions which generate at least part of the fuel of the fuel cell, which offers greater efficiency and flexibility than those of prior art. Such an improvement is provided in particular with means for storing at least part of the fuel coming from the chemical reactor and means for introducing on demand said fuel from said tank to said fuel cell. The fuel storing means allow great flexibility: the fuel produced by the chemical reactor may thereby not be used immediately by the fuel cell—this allows for adaptation of the production of electricity of the fuel cell to the external demand.

### CROSS-REFERENCE

The present patent application is a continuation-in-part of Ser. No. 17/869,459, filed Jul. 20, 2022, which in turns claims priority from French patent application No. FR2107884, filed Jul. 21, 2021; this continuation-in-part claims priority from French patent application No. FR2311050, filed Oct. 13, 2023.

### TECHNICAL FIELD

The present invention relates to an electricity production facility comprising a non-galvanic fuel cell.

### BACKGROUND OF THE INVENTION

Some hydrogen fuel cells are known to operate at high temperatures, ranging in particular from 200° C. to 1100° C. In these fuel cells, the dihydrogen is oxidized, either at the cathode, if the dihydrogen crosses the electrolyte in ionic form towards it, or at the anode if the dioxygen crosses the electrolyte towards the anode as in the case of SOFC solid oxide batteries. The energy efficiency of all these fuel cells, however, rarely exceeds 60% of the energy.

It is known to use the heat released by these batteries during their operation to operate turbines which also provide electricity. We then speak of co-production. However, the recovery of the heat released in the production of electricity is not sufficient.

The document JP2005306624A describes the use of the heat produced by the combustion in a burner of the residual gases from the fuel cell, to provide thermal energy to the reactors where the stages of separation and concentration of products intended for the production of dihydrogen take place, but does not recycle all the heat given off by the exhaust gas, the electrolyte nor the electrodes of the fuel cell in which the dihydrogen reacts with the dioxygen, possibly using only the part of the said heat transferred to the dioxygen and dihydrogen which do not have not reacted, and further requiring a combustion chamber in which the dioxygen burns the dihydrogen outside the electrochemical cell; while instead, the dihydrogen could be separated from the water with which it is mixed at the outlet of the anode by simple cooling under a pressure lower than the critical pressure of water, to be reintroduced at the inlet of said fuel cell, or else be separated by a membrane.

The document JPH09320627A describes a facility which makes it possible to use, when starting up the facility, the heat produced by a fuel cell using phosphoric acid as electrolyte. The fuel cell is completely powered by the chemical reactions taking place in the dihydrogen and dioxygen production unit, which operates with the heat generated by the fuel cell. This facility does not allow recycling of the products of the electrochemical reaction of the fuel cell, for the production of dihydrogen and dioxygen. In addition, the facility creates toxic co-products, the phosphorus reacting with the dihydrogen.

Documents US 2020/303758 and EP1851816A2 describe hydrocarbon reforming processes which allow the production of dihydrogen.

Ullmann's Encyclopedia of Industrial Chemistry (ISBN 978-3-52-730673-2) describes, in its chapter “Hydrogen, 2. Production”, various chemical processes for the production of dihydrogen, including processes for the decomposition of water into dihydrogen and dioxygen.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### Technical Problem

The aim of the present invention is to provide a facility for producing electricity comprising a non-galvanic fuel cell whose heat is recovered for implementing endothermic chemical reactions which generate at least part of the fuel of the fuel cell, which offers greater efficiency and flexibility than the above-mentioned prior art facilities.

### DESCRIPTION OF THE INVENTION

The present invention relates to an electricity production facility, comprising:
a non-galvanic fuel cell using a fuel and an oxidizer, generating a resulting product and operating at a given temperature,
a chemical reactor thermally connected to said fuel cell allowing the production of said fuel via an at least one endothermic chemical reaction which uses said resulting product and which takes place at a temperature lower than or equal to said operating temperature,
means for introducing, into said fuel cell, fuel coming from said chemical reactor and/or from outside said facility,
means for introducing, into said fuel cell, oxidizer coming from said chemical reactor and/or from outside said facility,
one or more thermal engines powered by electrical power for elevating the temperature of heat, such as heat pumps and Carnot heat engines, delivering the produced heat to at least one of the compartments of the reactor hosting an endothermic reaction,
wherein said facility further comprises at least a first tank for storing at least part of said fuel coming from said reactor and means for introducing on demand said fuel from said first tank to said fuel cell.

At least one heat engines of the facility may advantageously be reversible, producing electricity when decreasing the temperature of a heat source. This possibility enabling to produce more electricity when, for instance, the chemical reactor are is not used for producing any fuel.

The fuel from outside the facility enters the facility and mixes with the fuel possibly resulting from the reactor of the chemical cycle to be introduced into a fuel cell, said fuel cell producing electricity which is one of the products of the facility, as well as a resulting product which is partly extracted from the facility and partly recycled to the chemical cycle reactor, the heat released by the fuel cell being transferred to the chemical cycle which produces fuel.

The fuel storing tank allows great flexibility: the fuel produced by the chemical reactor may thereby not be used immediately by the fuel cell—this allows for adaptation of the production of electricity of the fuel cell to the external demand.

This is achieved when using all the electricity produced by the fuel cell to power the heat pumps bringing heat to the compartments of the chemical reactor and heat exchangers, by for instance restricting the amount of fuel fed to the fuel cell.

Such external demand can come for instance from the electrical engine of a car, where peaks of power demand can occur during accelerations, alternating with low or even negative (during braking for instance) power demand.

The external demand may also come from a household where various appliances can be turned off and on during the day.

The fuel cell is for example a solid oxide hydrogen cell whose combustion product is water, formed at the electrode in contact with the dihydrogen. A dihydrogen concentrator 150 is advantageously arranged to extract the water from the water-dihydrogen mixture, for example consisting of a metal membrane, of vanadium covered with silicon oxide on each face, themselves covered with a fine 20-micron layer of platinum as described in the article: “Hydrogen-permeable metal membranes for high-temperature gas separations” published by David Edlund, Dwayne Friesen, Bruce Johnson and William Pledge in 1994 in the journal “Gas Separation and Purification” Volume 8.

Alternatively, the fuel cell may be for instance a Protonic ceramic fuel cell, a Tubular solid oxide fuel cell, a Molten carbonate fuel cell, a Tubular solid oxide fuel cell (TSOFC), a Molten carbonate fuel cell, a Solid acid fuel cell, a Phosphoric acid fuel cell.

### Water Dissociation Processes

The resulting product from the fuel cell can be water, which can then be used in the chemical reactor through a process of thermal dissociation.

The thermal dissociation of water is for example the iodine sulfur cycle or any other similar cycle from hydrogen halide using for example bromine or chlorine instead of iodine, during which the reactions used are respectively 2H₂O+Br₂+SO₂->2HBr+H₂SO₄; 2HBr->H₂+Br₂; H₂SO₄→SO₂+H₂O+½O₂. Each of the products of the thermal dissociation of water can then be used in part by the hydrogen fuel cell. As a variant, the products dissociated by the thermal dissociation process all come from the overall chemical reaction taking place in the fuel cell, and all the products resulting from the thermal dissociation are consumed by said fuel cell.

The sulfur iodine cycle allows in a first reaction at for example 120° C. between di-iodine, sulfur dioxide and water to produce hydrogen iodide and sulfuric acid (I₂+SO₂+2H₂O→2HI+H₂SO₄), the hydrogen iodide being recycled in a first endothermic reaction at for example 650° C. in di-iodine and dihydrogen (2HI→I₂+H₂) and the sulfuric acid in sulfur dioxide, water and dioxygen (2H₂SO₄→2SO₂+2H₂O+½O₂) in a second endothermic reaction, for example at 830° C.; the heat required for the first and/or second endothermic reaction coming from the hydrogen fuel cell, either through a thermal connection between said fuel cell and the compartments of the first and/or second endothermic reaction, or/and transported to the said compartments by the water released from the hydrogen fuel cell during its operation.

Alternatively, the thermal water dissociation process can use an alkali metal hydride in which water mixed with the alkali metal reacts to form a hydride of the alkali metal and dioxygen (H₂O+2Me->2MeH+½O₂) while the alkali metal hydride is transformed in anothercompartment into metal and dihydrogen (2MeH->2Me+H₂).

Alternatively still, the dissociation of water can be done using Iron III chloride and Iron II chloride (6FeCl₂+8H₂O->2Fe₃O₄+12HCl+2H₂; 2Fe₃O₄+12HCl+3Cl₂->6FeCl₃+6H₂O+O₂ and 6FeCl₃->6FeCl₂+3Cl₂).

Alternatively still the dissociation of water can be done using vanadium chloride and vanadium tetrachloride (Cl₂+H₂O->2HCl+½O₂; 2HCl+2VCl₂->2VCl₃+H₂; 2VCl₃->VCl₂+VCl₄; 2VCl₄->2VCl₃+Cl₂).

In yet another version, the process for the thermal dissociation of water can use hydrocarbons, methane reacting for example in a first compartment with water to form dihydrogen and carbon monoxide (CH₄+H₂O->CO+3H₂), carbon monoxide and dihydrogen reacting in a second compartment to form methanol (CO+2H₂->CH₃OH), methanol reacting in a third compartment with arsenate to form arsenious anhydride and dioxygen (CH₃OH+As2O₄->CH₄+As₂O₅), a fourth and a fifth compartments allowing the formation of arsenate and dioxygen from arsenious anhydride (½As₂O₅->½As₂O₃+½O₂ and ½As₂O₅+½As₂O₃->As₂O₄).

The facility may comprise at least one fuel cell generating electricity and using a fuel, such as dihydrogen, as reducing fuel and operating at a given operating temperature, said fuel cell being connected to a main source of dihydrogen.

The facility may comprise a chemical reactor unit thermally connected to said fuel cell and allowing the chemical production of fuel from the product of the reaction taking place in the fuel cell, or from a chemical compound of the same composition, via at least an endothermic chemical reaction which takes place at a temperature less than or equal to said operating temperature of said battery, and means for introducing into said fuel cell the dihydrogen produced in said chemical reactor.

In a preferred embodiment of the invention, said chemical reactor comprises at least one main compartment allowing the chemical production of dihydrogen and di-iodine from hydrogen iodide (HI), a first secondary compartment allowing the chemical production of dioxygen from sulfuric acid (H₂SO₄), and/or at least a second secondary compartment which allows the reaction between di-iodine, sulfur dioxide and water, which produces hydrogen iodide and sulfuric acid. This second secondary compartment therefore contains diatomic iodine, water and sulfur dioxide and possibly the products of this reaction, i.e. hydrogen iodide and sulfuric acid. Said first secondary compartment and/or said main compartment are thermally connected to said fuel cell. The production unit further comprises means for introducing di-iodine produced in said main compartment to the second secondary compartment, means for introducing sulfuric acid produced in said second secondary compartment in said first secondary compartment and means for introducing the dioxygen produced in said first secondary compartment to said fuel cell, so that the latter serves there as oxidizer.

The cycles of the dihydrogen/dioxygen production reactions are not limited according to the invention. This may be, for example, one of the water-splitting processes described above.

The fuel cell of the facility of the invention is connected to a main source of fuel and to a main source of oxidizer. The supply of fuel and oxidizer provided by the operation of the chemical unit or the chemical reactor is an additional fuel and/or oxidizer contribution.

Advantageously, the chemical reactor comprises at least one main compartment allowing the production of dihydrogen from hydrogen iodide, a first secondary compartment allowing the reaction between two molecules of sulfuric acid to produce in particular dioxygen and at least one second secondary compartment which allows the reaction between di-iodine, sulfur oxide and water to produce sulfuric acid and hydrogen iodide. The cycle used is then that described in FIG. 1.

The facility according to the invention therefore makes it possible to produce, at the same time, electricity, dihydrogen and dioxygen, which are used as fuel in the cell within said facility. The heat generated continuously by the hydrogen fuel cell during its operation is used for the production of dihydrogen and/or dioxygen during endothermic reactions and the remaining heat, if any, can still be used for the production electricity by a turbine or for heating, for example.

According to a variant that can be combined with each of the aforementioned embodiments, the fuel cell is thermally connected only to said first secondary compartment, the main compartment being thermally connected to the first secondary compartment and to the second secondary compartment.

According to another variant, the fuel cell is thermally connected to the three compartments.

The chemical reactor includes compartments thermally connected to each other, either directly by contact or by a heat transfer fluid circuit. The use of a heat exchanger operating with a heat transfer fluid makes it possible to regulate the flow of heat transmitted by regulating the flow of heat transfer fluid. A heat transfer fluid can circulate in the walls of the main compartment to lower the temperature and transfer the calories which have passed through said walls, which are themselves preferably wrapped up for thermal insulation, to the second secondary compartment.

The chemical reactor can be configured to receive the heat released by the fuel cell directly by convection or conduction. The facility may also comprise means of thermal connection between said fuel cell and said main compartment and/or between said fuel cell and said first secondary compartment which make it possible in particular to continuously supply the heat given off by said fuel cell and regulate the amount of heat supplied. These thermal connection means can be or include, for example, a heat transfer fluid circuit circulating between the fuel cell next to the anode and cathode, and the reactor.

The endothermic chemical reaction 2HI->I₂+H₂ can take place in the gas phase at 830° C. The main compartment therefore contains hydrogen iodide and possibly the reaction products (i.e. dihydrogen and di-iodine).

The first secondary compartment allowing the reaction between two molecules of sulfuric acid to produce dioxygen (this compartment therefore contains at least sulfuric acid and possibly the reaction products i.e. sulfur dioxide, water and dioxygen) The second secondary compartment allows the reaction between di-iodine, sulfur oxide and water, which produces hydrogen iodide and this second secondary compartment therefore contains diatomic iodine, water and sulfur dioxide and possibly the products of this reaction, i.e. hydrogen iodide and sulfuric acid. Said secondary compartments may be thermally connected to said main compartment and/or to said fuel cell.

Indeed, the publication entitled “Sulfur-Iodine Thermochemical Cycle”, by P. Pickard, and published on May 17, 2006 in the journal Sandia National Labs, describes a series of reactions allowing the production of dihydrogen that respects the environment. The aforementioned Sulfur-Iodine cycle makes it possible, using high heat, to produce dihydrogen. The reaction I₂+SO₂+2H₂O→2HI+H₂SO₄ operates at 120° C. The two endothermic reactions: 2H₂SO₄→2SO₂+2H₂O+O₂ and 2HI→I₂+H₂ are preferably carried out, respectively at 830° C. and 650° C., the SOFC fuel cell preferably operating at 860° C. or more.

Throughout the present application, the expression “reactor allowing the reaction between A and B” encompasses a reactor containing the reactants A and B and optionally the products and by-products of this reaction.

Advantageously, said operating temperature of said fuel cell is greater than or equal to 850° C. or 860° C. It is advantageously less than or equal to 1000° C. or 1100° C.

The fuel cell is not limited according to the invention. It can be a proton exchange membrane hydrogen fuel cell or a solid oxide hydrogen fuel cell (SOFC). It can also be, for example, a direct methanol cell, for example with a solid oxide electrolyte whose fuel is methanol; the reactions then being at the anode: CH₃OH+3O₂_{^{−}}→CO₂+2H₂O+6 e⁻ and at the cathode: O₂+4 e⁻→2 O²⁻; then the carbon dioxide separated from the water, for example cooling and pressurizing for example at 30° C. under 1 atmosphere so that the water becomes liquid while the carbon dioxide remains gaseous; the water being regenerated into dihydrogen by one of the processes described above for dissociation of water, then the dihydrogen reacting in a separate compartment with carbon dioxide to form methanol according to the reaction: CO₂+3 H₂->CH₃OH+H₂O.

The fuel cell is advantageously chosen from solid oxide fuel cells, which have a high operating temperature, that is to say, greater than 850° C.

According to the invention, the solid electrolyte of the SOFC battery (“solid oxide fuel cells”) is not limited. As this is a solid electrolyte of metal oxide(s) type, it can, for example, be chosen from yttrium oxides stabilized with zirconium (YSZ), scandium oxides stabilized with zirconium, (ScSZ), gadolinium doped with/with cerium oxides (GDC), bismuth stabilized with erbium oxide(s) (ERB), cerium oxides doped with one or more samarium oxides and mixtures of at least two of these oxides.

As this is a solid electrolyte containing or consisting of ceramics, it can, for example, be chosen from ceramics and in particular composite ceramics containing salts of cerium oxide(s), (CSCs).

The means of introduction into the chemical reactor can be simple pipes possibly equipped with nozzles preceded by compressors. The phase of di-iodine and sulfuric acid during their reintroduction is not limiting according to the invention. They can be liquid or gaseous, independently of each other, depending on the temperature and pressure conditions in the separators that equip the outlets of the reactor compartments.

The facility of the invention thus makes it possible to produce both dihydrogen and dioxygen which are used in the electrochemical reaction of the fuel cell. The facility of the invention can therefore operate with a reduced supply of dihydrogen and/or external dioxygen. It is therefore particularly ecological and proves to be economically advantageous.

The facility of the invention can be used to produce electric current, for example for industrial or domestic use, added to one or more electric motors for moving vehicles.

The present invention also relates to a method for operating the electricity production facility described above, comprising:
assessing the demand of electricity to be produced by said facility,
assessing the available electricity than can be powered from outside to the facility,
assessing the quantities of fuel, oxidizer and resulting product that are available for the facility, both from inside and outside the facility,
and, depending on the outcome of this assessment, processing the following operations, alone or in any possible combination:
producing electricity with the fuel cell with fuel and oxidizer coming from the reactor,
producing electricity with the fuel cell with fuel and oxidizer coming from said first and second tanks,
producing electricity with the fuel cell with fuel and oxidizer coming from outside said facility,
using said heat pump for heating said reactor and producing said fuel and said reactor,
powering said heat pump with electricity generated by said fuel cell,
powering said heat pump with electricity coming from outside the facility,
using resulting product coming from said fuel cell,
using resulting product coming from outside the facility,
powering said fuel cell with electricity from outside the facility so that it operates as an electrolyzer and generates fuel and oxidizer,
using directly the fuel and/or oxidizer and/or resulting product or storing it for future use.

The fuel cell can use for instance dihydrogen as a reducing fuel, the heat produced during the operation of said fuel cell being continuously used to chemically generate dihydrogen via the endothermic chemical reaction 2HI→I₂+H₂, said dihydrogen then possibly being introduced into said cell to serve there as fuel.

### Definitions

The terms “thermally connected” indicate that two or more elements are in a thermal relationship either directly, by contact allowing the phenomenon of conduction, or by means of a suitable liquid or gaseous heat transfer fluid such as, for instance, oil.

The term “solid oxide” designates within the meaning of the invention a metal oxide allowing the transport of O²⁻ ions.

The terms “solid oxide fuel cell” designate any electrochemical device making it possible to produce electricity by oxidation of a fuel and comprising a solid electrolyte which may be a solid metal oxide, a mixture of metal oxides or a ceramic.

### FIGURES

The present invention, its characteristics and the various advantages it provides will appear better on reading the following description, presented by way of illustrative and non-limiting example, and which refers to the appended FIGS. 1 to 7:

FIG. 1 is a schematic view showing in particular the chemical reactor of a facility according to the present invention.

FIG. 2 represents a diagram of the various flows of material and energy entering, leaving and internal to the main parts of the facility of FIG. 1.

FIG. 3 represents a diagram of the various flows of material and energy entering, leaving and internal to the main parts of a facility according to the present invention, the fuel being methanol.

FIG. 4 represents a diagram of the various flows of material and energy when using a dihydrogen-water separator making it possible to maintain the proportion of dihydrogen in the gaseous mixture supplied to the anode of the cell.

FIG. 5 is a schematic view showing in particular at least one heat pump of a facility according to the present invention.

FIG. 6 represents a variant of embodiment of FIG. 5.

FIG. 7 represents a complete electricity production facility according to the present invention.

### EXAMPLES

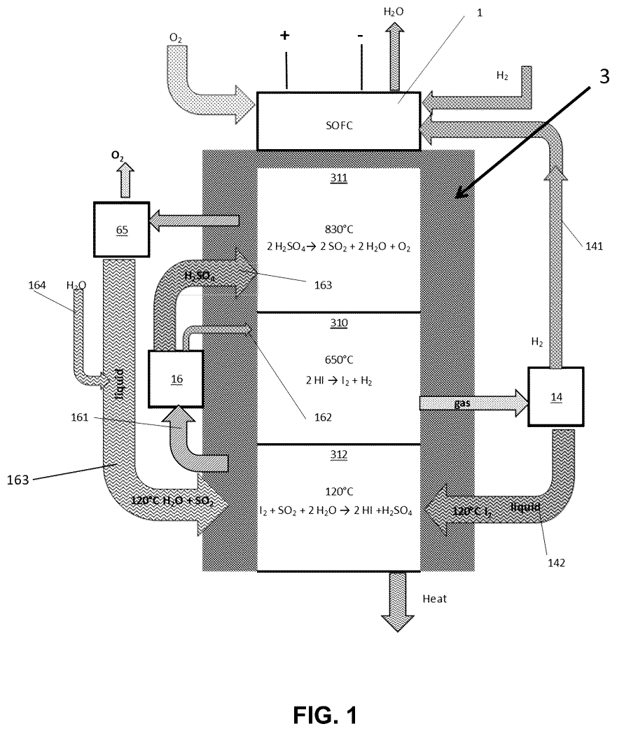

FIG. 1

With reference to FIG. 1, the facility comprises a cell 1, which is a solid metal oxide fuel cell. Despite its operation at high temperature (from 850° C. to 1000° C.), cell 1 gives off heat. Cell 1 is thermally connected to a chemical reactor 3, which has three compartments. A thermal gradient is present in the chemical reactor 3 in order to ensure the appropriate reaction temperatures. The two upper compartments of the reactor are thermally connected to each other. The chemical reactor 3 comprises a main compartment 310 which is central in FIG. 1. A first secondary compartment 311 is located above the main compartment 310. This first secondary compartment 311 is arranged so as to first recover the heat produced by the fuel cell 1 so that the temperature within it is higher than in the main compartment 310. A second secondary compartment 312 is arranged under the main compartment 310; the di-iodine from the separator 14 is advantageously brought into the tank 312 at a temperature of 120° C. in liquid form. A mixture of water and sulfur dioxide is supplied from the separator 65 and from a supply of water introduced via line 164, preferably also at a temperature of 120° C., and preferably under a pressure allowing that the two components of this gaseous mixture are liquid, the partial pressure of the sulfur dioxide being for example 50 bars.

The temperature of the second secondary compartment 312 is lower than that of the main compartment 310. In FIG. 1, the two upper compartments are thermally connected so that the heat is transmitted from the first secondary compartment to the main compartment. The arrangement of the compartments is not limited to that shown in FIG. 1. In particular, the compartments may not have a common wall through which the heat is transmitted. For example, a heat transfer liquid whose speed is regulated circulates between the 3 compartments to heat the said compartments and maintain them at the temperature necessary for the chemical reactions they house, if these are the sites of endothermic reactions.

The residual heat resulting from the operation of the facility is evacuated at the level of the second secondary compartment 312, for example by means of a cooling circuit (not shown) in which a heat transfer liquid circulates. A portion of this circuit crosses said compartment or is in contact with the wall of the latter. This heat can be used, for example, to produce electricity by means of a turbine. For this purpose, the facility may also include an electricity production turbine.

Still with reference to FIG. 1, the facility comprises a gas separator 14 whose inlet is located at the outlet of the main compartment 310. The outlet of this separator 14 is connected by a pipe 141 to the fuel cell and by a pipe 142 to the second secondary compartment 312. The separator 14 can operate for example by concomitant expansion and cooling of the gas coming from the compartment 310, the di-iodine becoming liquid, between 184° C. and its critical temperature being 545.8° C. The liquid di-iodine is then optionally recompressed to reach the operating pressure of compartment 312.

The facility also comprises a separator 16 arranged at the entrance to the main compartment 310. The entrance to the separator 16 is connected via a pipe 161 to the second secondary compartment 312. The exit from the separator 16 is connected on the one hand to the main compartment 310 via a pipe 162 and on the other hand to the first compartment 311 via another pipe 163. At a temperature of 120° C., hydrogen iodide HI is gaseous and the other components, including sulfuric acid, are liquid under 50 bars. The reaction product mixture from compartment 312 is therefore preferably withdrawn from said compartment 312 after the reaction is complete. The pressure of the hydrogen iodide is advantageously lowered to the operating pressure of the compartment 310, to for example 10 bars.

A third separator 65 has its inlet connected to the first secondary compartment 311 (pipe not referenced and indicated by an arrow in FIG. 1) and its outlet connected by a first pipe (not shown) to the battery 1 and by a second pipe, to the second secondary compartment 312. The separator 65 operates for example by one or a series of compressions followed by cooling of the gas resulting from the decomposition of the sulfuric acid.

The operation of the facility will now be described with reference to FIG. 1. In the main compartment 310, the following chemical reaction takes place:

2HI→I₂+H₂

This reaction takes place at a temperature of about 650° C. in the gas phase.

In the first secondary compartment 311, the following chemical reaction takes place:

2H₂SO₄→2SO₂+2H₂O+O₂

This reaction takes place at a temperature of about 830° C. in the gas phase.

In the second secondary compartment, the following chemical reaction takes place:

I₂+SO₂+2H₂O→2HI+H₂SO₄

This reaction is endothermic and takes place at a temperature of the order of 120° C., the liquid di-iodine, mixed with liquid water and sulfur dioxide reacting advantageously with each other or, alternatively for example, the di-iodine in liquid form being vaporized in an atmosphere composed of water vapor and sulfur dioxide.

Fuel cell 1 produces electricity supplying a network or any electrical device such as the electrical engine of a car, not shown in FIG. 1, by consuming dihydrogen. The heat given off by cell 1 is used to heat the first secondary compartment 311 of chemical reactor 3. In the particular embodiment represented here, only this compartment is thermally connected to fuel cell 1. In this first secondary compartment, the sulfuric acid reacts on itself to produce water, dioxygen and sulfur dioxide. The reaction products are separated in the separator 65; the sulfur dioxide and the water are brought into the second secondary compartment 312; the dioxygen is brought to fuel cell 1 to serve, in addition to the dioxygen brought from elsewhere, for example from outside air, to the oxidation-reduction reaction which takes place in the latter.

Due to the heat supplied, either directly from fuel cell 1, or after transit in the first secondary compartment 311, the reaction which takes place in the main compartment 310 produces gaseous di-iodine and gaseous dihydrogen. These produced gases are separated in the separator 14; the dihydrogen is routed (via line 141) to fuel cell 1 to react there. The gaseous iodine leaving the separator 14 is routed via line 142 to the second secondary compartment 312.

In the second secondary compartment 312, iodine reacts with sulfur dioxide and water from the first secondary compartment to produce hydrogen iodide (HI) and sulfuric acid. These products are separated in the separator 16; the hydrogen iodide is separated and brought to the main compartment 310 in order to feed the reaction in the latter; the sulfuric acid is brought into the first secondary compartment by line 163 connected to separator 16.

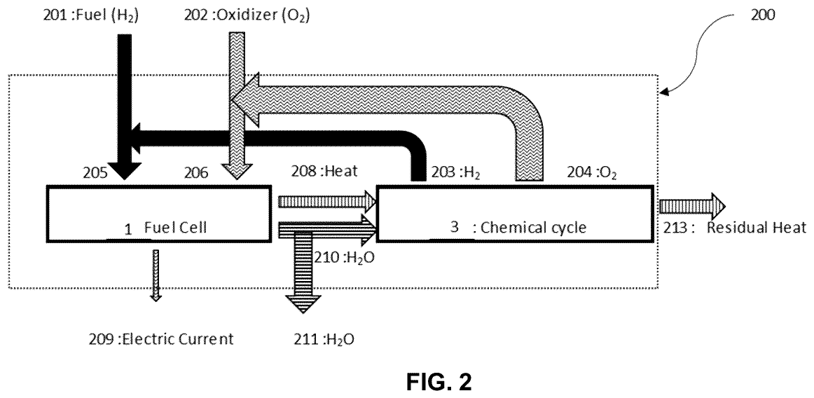

FIG. 2

The fuel 201 enters the facility 200 and mixes with the fuel 203 from the chemical cycle reactor 3 to be introduced at 205 into the fuel cell 1. Similarly, the oxidizer is introduced 202 into the facility to be mixed with the oxidizer 204 from the chemical cycle reactor 3, to be introduced at 206 into the fuel cell 1. The fuel cell 1 produces electricity 209 which is one of the products of the facility, as well as a resulting product—for example water—which is partly extracted from the facility at 211 and partly recycled at 210 to the reactor of the chemical cycle. The heat 208 given off by the fuel cell 1 is transferred to the chemical cycle reactor 3. The chemical cycle reactor 3 produces fuel 203, oxidizer 204 and possibly residual heat 213 extracted from the facility.

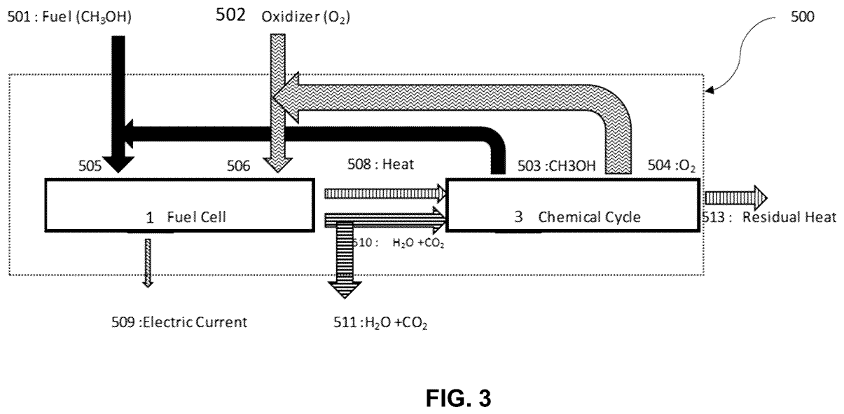

FIG. 3

The methanol 501 enters the facility 500 and mixes with the methanol 503 from the chemical cycle reactor 3 to be introduced at 505 into the direct methanol fuel cell 507. Similarly, the dioxygen is introduced into the facility 502 to be mixed with the dioxygen 504 from the chemical cycle reactor 3, to be introduced at 506 into the fuel cell 1. The fuel cell 1 produces electricity 509 which is one of the products of the facility, as well as water and carbon dioxide 511 which are partly extracted from the facility at 511 and partly recycled at 510 to the reactor of the chemical cycle 3. The heat 508 released by the fuel cell 507 is transferred to the chemical cycle reactor 3. The chemical cycle reactor 3 produces methanol 503; dioxygen 504 and possibly residual heat 513 extracted from the facility.

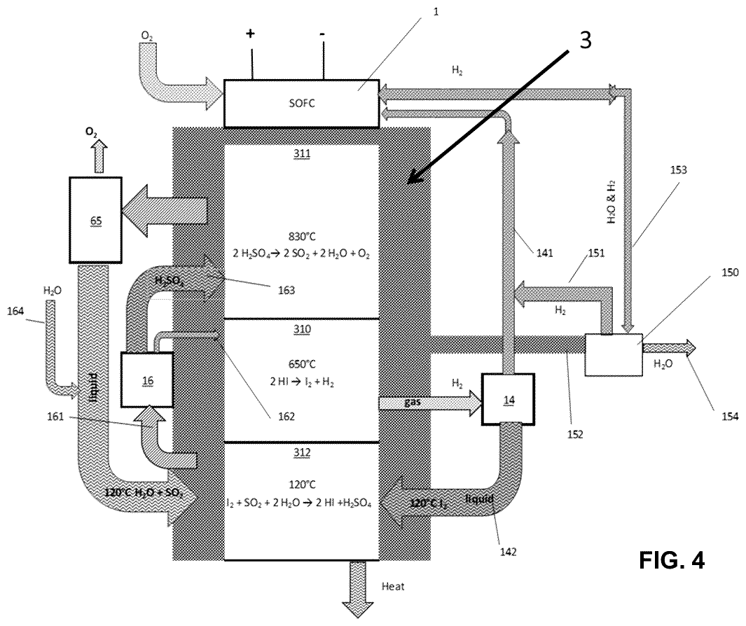

FIG. 4

The gaseous mixture brought to the anode of the fuel cell 1 is put into circulation, that is to say brought and withdrawn by the line(s) 153 to be in thermal and gaseous communication with the device 150 which is in thermal contact by the connection 152 with the compartment 310 at a temperature of approximately 650° C. to which said gas mixture is therefore cooled. The gaseous mixture is enriched in dihydrogen in the device 150 using one or more metal membranes which makes it possible to extract the dihydrogen therefrom and/or the water which is rejected by the pipe 154. This water is advantageously used in part (not shown), to supply the dihydrogen production cycle, then being introduced into line 164. Similarly, the heat from this water is advantageously supplied to compartment 312 (not shown), or to heat the dihydrogen and/or dioxygen introduced into the facility.

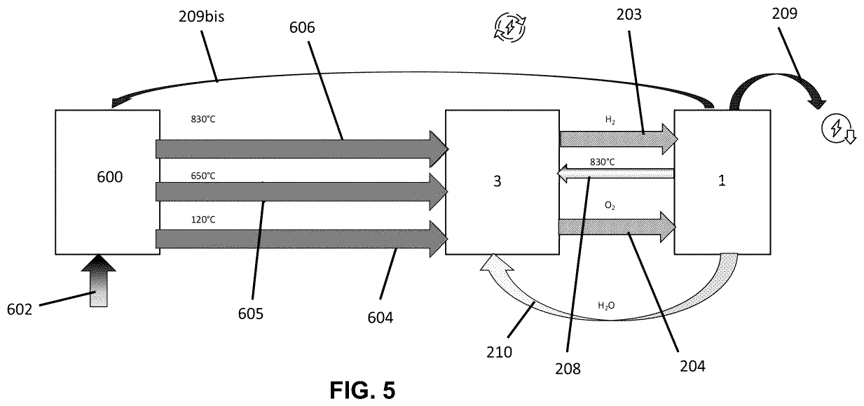

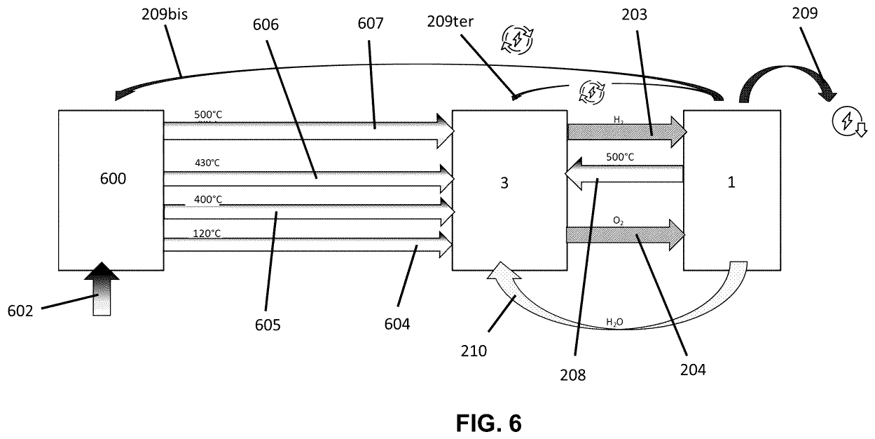

FIGS. 5 and 6 show two variants of the use of at least one heat pump in a facility according to the present invention.

The cumulative use of the heat produced by the heat pump can make it possible to generate a sufficient quantity of fuel, and thus can make the process self-sufficient in fuel consumption.

Referring to the embodiment shown in FIG. 5, a hydrogen fuel cell, in which the fuel is dihydrogen-201, oxidized by dioxygen-202 in an electrolytic system, has been depicted.

This oxidation reaction allows the circulation of electrons between the anode and the cathode of the electrolytic system, and thus the production of electricity 209.

This oxidation reaction also produces water 211 and releases a significant amount of heat 208, typically reaching a temperature of around 830° C.

As taught above the heat 208 released by the hydrogen fuel cell 1 can be recovered to produce dihydrogen in reactor 3 using a cascade of endothermic chemical reactions, such as the iodine/sulfur cycle reactions mentioned above, or bromine/sulfur cycle reactions, or chlorine/sulfur cycle reactions, or reactions using alkali metal hydride, or reactions using iron III chloride and iron II chloride, or vanadium chloride and vanadium tetrachloride.

In the present embodiment, at least one heat pump 600 is provided, powered by a fraction 209bis of the electricity 209 produced by the hydrogen fuel cell 1.

This heat pump 600 is used to raise the temperature of a cold source 602 (typically around 20° C. but also warmer, e.g. 80° C.) such as ambient air, river water, sea water or from a geothermal facility, to different temperatures 604, 605, 606 that are needed to implement endothermic reactions for dihydrogen production in reactor 3.

The term “heat pump” used in the present invention may refer to a plurality of heat pumps and/or a heat pump comprising a plurality of cascade cycles whose compressible gases operate at temperatures below their critical temperatures and above their boiling temperatures.

For example, gaseous mercury, sulfur, water vapor, bromine, chlorine, R290 gas or R32 gas can be used as gases in the heat pumps. The Carnot engines may also user super critical gas such as helium.

For example, when the iodine/sulfur cycle is used to produce dihydrogen, heat transfer fluids can be circulated between heat pump 600 and the various reactor 3 at temperatures of 830° C., 650° C. and 120° C. respectively, making it possible to implement the following three endothermic reactions for dissociation of the water 210 supplied by fuel cell 1 respectively:

2H₂SO₄→2SO₂+2H₂O+O₂

HI→I₂+H₂

I₂+SO₂+2H₂O→2HI+H₂SO₄

By recovering the heat 604, 605, 606 generated by heat pump 600, sufficient energy is provided to generate the quantity of dihydrogen 3 necessary for the autonomous operation of hydrogen fuel cell 1, i.e. for operation that does not require the external supply of fuel.

By also recovering the heat 208 generated by hydrogen fuel cell 1, to generate dihydrogen 203, we can reduce the share of electricity taken from the production of the fuel cell for the thermochemical production of dihydrogen.

In some cases, it may be necessary to use the heat 208 released by fuel cell 1 to ensure that the amount of dihydrogen produced by thermochemical reactions is sufficient for the operation of the fuel cell.

In the embodiment shown in FIG. 6, water dissociation reactions include endothermic chemical reactions on the one hand, and at least one electrolysis reaction on the other.

In particular, a five-step cycle using copper and chlorine can be used, as described in the article “Energy analysis of heat exchangers in the copper-chlorine thermochemical cycle to enhance thermal effectiveness and cycle efficiency”, published in the “International Journal of Low-Carbon Technologies, Volume 6, Issue 3, September 2011”.

The five steps E1 to E5 of this cycle are as follows:

TABLE 1

| | Power | Reaction | | |
|---|---|---|---|---|
| Steps | source | temperature | | Reactions |
| E1 | heat | 400° | C. | 2CuCl₂(s) + H₂O(g) → |
| | | | | CuO•CuCl₂(s) + 2HCl(g) |
| E2 | heat | 500° | C. | CuO•CuCl₂(s) → 2CuCl(l) + |
| | | | | 1/2O₂(g) |
| E3 | electricity | 25-80° | C. | 4CuCl(s) + H₂O → 2CuCl₂(aq) + |
| | | | | 2Cu(s) |
| E4 | heat | >100° | C. | CuCl₂(aq) → CuCl₂(s) |
| E5 | heat | 430-475° | C. | 2Cu(s) + 2HCl(g) → 2CuCl(l) + |
| | | | | H₂(g) |

The reaction of the E3 step is electrolytic in nature, and therefore requires an input of electricity.

Advantageously, this contribution is taken 209ter from the electricity 209 produced by the hydrogen fuel cell 1.

In the case of the endothermic chemical reactions of stages E1, E2, E4 and E5, the required reaction temperatures 605, 607, 604 and 606 of 400° C., 500° C., 120° C. and 430° C. respectively are provided by heat transfer fluids circulating between heat pump 600 and dihydrogen production reactor 3 in which these different reactions take place.

Advantageously, a thermal engine (not shown) can be used to lower the temperature given off by the hydrogen fuel cell from 830° C. to 500° C. in order to implement the above-mentioned E2 stage, this thermal engine providing an additional source of electricity production.

According to a variant of this embodiment, the above-mentioned iodine/sulphur cycle can be used to produce dihydrogen, but the HI→I₂+H₂ step can be carried out using a proton exchange membrane cell operating between 50° C. and 100° C., e.g. at 80° C.

Such a membrane cell can operate by taking part of the electricity produced by hydrogen fuel cell 1.

Such a membrane cell has advantageously a catalyst at its electrodes, such as platinum or cerium gadolinium oxide (CGO) Ce0.9Gd0.1O1.95 developed in particular by the company Cres Power Ltd.

As will be understood in light of the above, the embodiments of FIG. 5 and FIG. 6 make it possible to operate a fuel cell autonomously, i.e. without an external supply of fuel.

This autonomy is obtained by pumping the heat in the environment with energy produced by the fuel cell itself.

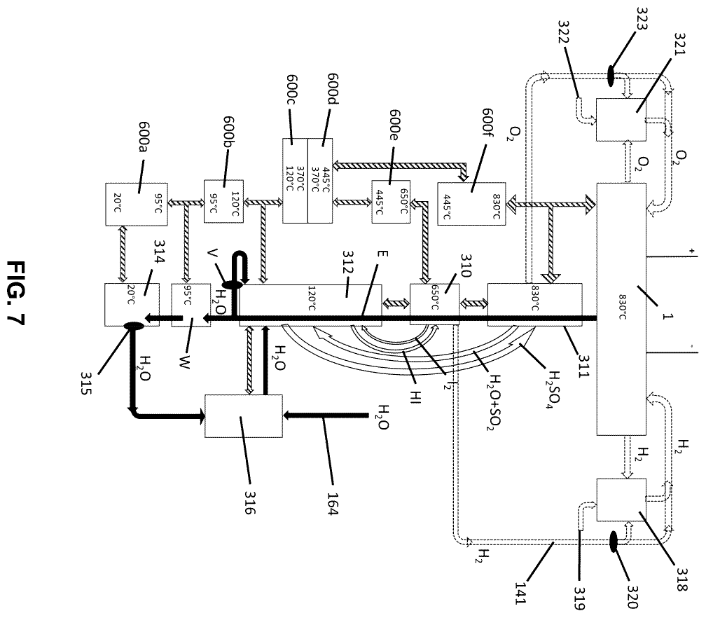

Reference is now made to FIG. 7, in which a complete embodiment of an electricity production facility according to the invention is shown.

In this figure, references identical or analogous to those in the previous figures designate identical or similar organs or sets of organs.

Hatched arrows indicate heat exchange, dotted arrows indicate gas circulation lines, solid line arrows indicate liquid circulation lines, and black-filled arrows indicate water circulation lines.

On this figure, heat exchangers used to bring chemical reactor inputs and products up to temperature, as well as any equipment for separating chemical elements supplying or taking heat from heat pumps, are not shown.

Gas dissociation devices are preferably located after the heat exchangers cooling them, in particular for the mixture of SO₂+H₂O+½O₂ for which the separation of oxygen is preferably made at 120° C., and for the mixture HI, I₂ and H₂ preferably made at 175° C., i.e. a little below the boiling temperature of sulfur, the diode is therefore liquid at this temperature, (which allows a greater stability of the membranes).

The dissociation processes can include compressors and decompressors which are not displayed on FIG. 7, allowing to increase the pressure of the gases to be dissociated as they pass through the porous membrane, or after it.

The energy can be recovered during decompression, for example in electrical form by a turbine.

Symmetrical compressors driven by linear motors can be used. A symmetrical compressor has 2 chambers to compress the gas to and from the engine. As can be seen in FIG. 7, the facility comprises a plurality of heat pumps 600a-600f, each of which makes it possible to raise the temperature of heat transfer fluids from a low temperature value to a high temperature value, these two values being indicated in each of the rectangles representing heat pumps.

These heat pumps can be of various types, including the type that uses the latent heat from the transition from the liquid to the gaseous state, or the gas-to-gas type of Sterling engine—the gas used can then be a supercritical gas such as helium, or mercury.

The heat transfer fluids from each heat pump circulate between these pumps, around the different compartments 310, 311, 312 of the chemical reactor 3, and around fuel cell 1.

In the facility of FIG. 7, a tank 314 for the recovery of water produced by fuel cell 1 is provided, communicating through a flow regulator 315 with a water filling tank 316, which can be filled with water from the outside via a filling line 164.

Water which is heated by fuel cell 1 in the state of steam, goes through compartments 310, 311, 312 of the chemical reactor 3, via heat exchangers E that can provide heat required for the endothermic reactions taking place in these compartments.

A regulating valve V can adjust the quantity of steam inside second secondary compartment 312, depending for instance on the concentration of water in this compartment, and/or on the flow of I₂ or SO₂ entering therein.

If necessary, the missing quantity of water can be provided by tank 316.

A reserve of water W at around 95° C. is also provided, this reserve being fed by steam going through exchangers E.

A tank of dihydrogen 318 is also provided, which can be filled with dihydrogen from the main compartment 310 of the chemical reactor 3 and/or with dihydrogen from fuel cell 1 when it is operated in electrolysis mode, and/or with dihydrogen from the outside via a filling line 319.

A flow regulator 320 modulates the amount of dihydrogen going to the dihydrogen tank 318 and to fuel cell 1 respectively.

Similarly, a dioxygen 321 tank can be filled with dioxygen from the first secondary compartment 311 of the chemical reactor and/or with dioxygen from fuel cell 1 when the latter is operating in electrolysis mode and/or with dioxygen from the outside by means of a filling line 322.

An external source of oxygen such as a tank or an oxygen separation unit extracting oxygen out of air can also be advantageously added to the facility.

A flow regulator 323 modulates the amount of dioxygen going to dioxygen tank 321 and fuel cell 1 respectively.

The embodiment of FIG. 7 offers great flexibility of operation.

Fuel cell 1 can use dihydrogen and dioxygen either directly from the thermal dissociation reactions of water taking place in compartments 310, 311, 312 of chemical reactor 3, or from tanks 318 and 321 respectively in which dihydrogen and dioxygen have been stored.

This storage will have been carried out with dihydrogen and dioxygen that can come from:
the said thermal dissociation reactions of water or
from the fuel cell 1 which will have been supplied with water and electricity in such a way as to operate it in electrolysis mode, the water being able to come in particular from tank 316 or
from the filling of tanks 318 and 321 with dihydrogen and dioxygen from outside.

These different sources of dihydrogen and dioxygen can also be used in combination.

The fuel cell can therefore also be used as an electrolyser, providing dihydrogen, oxygen and heat out of water and electricity, the heat being recycled for heating the chemical reactor and thereby providing a very fast mode of recharging a hydrogen tank when the facility is connected to the grid, the electricity grid powering the electrolyser and the heat pumps to make full use of both the electrolyser and the chemical reactor.

The different stages of heat pumps 600a to 600f allow the different compartments of chemical reactor 3 to be optimally heated.

Alternatively the main compartment 310 can operate at a lower temperature, for instance 200° C.; in this case the heat pump 600b can take the cold heat from a different source, for instance from the water tank W set operating at 95° C.

The water tank W allows to capture the latent energy of condensation of the exhaust gas of the fuel cell at high temperature, so that such latent energy can be reused to provide heat at a higher temperature using a heat pump consuming less electricity than if the latent energy had been recovered at a lower temperature.

In practice, the electrical power supplied by the fuel cell can typically vary from 0 kW if all the electricity produced by this fuel cell is used to power the heat pumps to produce dihydrogen only and quickly fill tank 318, to 18 kW if only dihydrogen from outside or stored in tank 318 is used, that is, if no heat pump is used.

According to the inventor's calculations, when using only dihydrogen produced by chemical reactor 3, the electrical power supplied by fuel cell 1 can typically be in the order of 3 kW for a facility comprising a fuel cell consuming 0.1 mol/second of dihydrogen.

As can therefore be understood in the light of the above, the electricity production facility according to the invention offers a high degree of flexibility.

It can typically operate 24 hours a day, and depending on the electricity production needs as they may result from a demand assessment, this facility may operate in any one of the following modes, which can be combined with each other if necessary:
electricity production mode:
   by using dihydrogen and dioxygen from the tanks 318, 321,
   by using dihydrogen and dioxygen directly from outside,
   by using dihydrogen and dioxygen from chemical reactor 3,
dihydrogen and dioxygen production mode, which can be stored in tanks 318, 321, or directly used by fuel cell 1:
   by supplying heat pumps 600a to 600f with electrical power coming from outside or from fuel cell 1,
   by supplying the fuel cell 1 with cold heat from the environment.

In another embodiment of the invention, the produced dihydrogen can be used to generate ammonia, and then urea (CO(NH₂)₂) and other fertilizers.

According to the inventor, such a 0.1 mol/second facility can generate about 60t of such fertilizer in a year.

Urea can be obtained from ammoniac through the two following reactions: CO₂+2NH₃⇔NH₂COONH₄ and NH₂COONH₄→CO(NH₂)₂+H₂O and ammonia from dihydrogen through the following reaction: N₂(g)+3H₂(g)⇄2NH₃(g).

The product resulting from the combustion of dihydrogen, namely water, can be stored in tank 316, for later use.

As an example of the operating strategy of the facility on the invention, during periods when electricity is not required, heat pumps 600a to 600f can be electrically powered in such a way as to rapidly produce dihydrogen and dioxygen which are stored in tanks 318 and 321, with a view to their subsequent use by fuel cell 1 to produce electricity.

1. An electricity production facility, comprising:
a non-galvanic fuel cell using a fuel and an oxidizer, generating a resulting product and operating at a selected temperature,
a chemical reactor thermally connected to said fuel cell allowing the production of said fuel via an at least one endothermic chemical reaction which uses said resulting product,
means for introducing, into said fuel cell, fuel coming from said chemical reactor and/or from outside said facility,
means for introducing, into said fuel cell, oxidizer coming from said chemical reactor and/or from outside said facility,
wherein said facility further comprises at least a first tank for storing at least part of said fuel coming from said reactor and means for introducing on demand said fuel from said first tank to said fuel cell.

2. The electricity production facility according to claim 1, further comprising means for introducing into said first tank said fuel coming form said fuel cell when the latter is operated in electrolysis mode.

3. The electricity production facility according to claim 1, further comprising at least a second tank for storing at least part of said oxidizer coming from said reactor and means for introducing on demand said oxidizer from said second tank to said fuel cell.

4. The electricity production facility according to claim 1, further comprising means for introducing into said second tank said oxidizer coming form said fuel cell when the latter is operated in electrolysis mode.

5. The electricity production facility according to claim 1, further comprising at least a third tank for storing at least part of said resulting product coming from said fuel cell and means for introducing on demand said resulting product from said third tank to said reactor.

6. The electricity production facility according to claim 1, further comprising at least one heat pump thermally connected to said fuel cell and so said reactor.

7. The electricity production facility according to claim 1, wherein said fuel is dihydrogen, said oxidizer is dioxygen, said resulting product is water and wherein said chemical reactor comprises:
at least one main compartment for chemical production of dihydrogen and di-iodine form iodide of hydrogen,
a first secondary compartment for chemical production of dioxygen from sulfuric acid,
a second secondary compartment for production of hydrogen iodide and sulfuric acid from di-iodine, sulfur oxide and water
and wherein said main compartment and/or said secondary compartment are thermally connected to said fuel cell,
means for introducing di-iodine produced in said main compartment into said second secondary compartment,
means for introducing sulfuric acid produced in said second secondary compartment into said first secondary compartment,
means for introducing dihydrogen produced in said main compartment into said fuel cell so that the latter serves there as fuel,
means for introducing dioxygen produced in said first secondary compartment into said fuel cell so that the latter serves there as fuel oxidizer,
and wherein said main compartment and said first and second secondary compartments are thermally connected to said fuel cell.

8. A method for operating an electricity production facility according to claim 1, comprising:
assessing the demand of electricity to be produced by said facility,
assessing the available electricity than can be powered from outside to the facility,
assessing the quantities of fuel, oxidizer and resulting product that are available for the facility, both from inside and outside the facility,
and, depending on the outcome of this assessment, processing the following operations, alone or in any possible combination:
producing electricity with the fuel cell with fuel and oxidizer coming from the reactor,
producing electricity with the fuel cell with fuel and oxidizer coming from said first and second tanks,
producing electricity with the fuel cell with fuel and oxidizer coming from outside said facility,
using said heat pump for heating said reactor and producing said fuel and said reactor,
powering said heat pump with electricity generated by said fuel cell,
powering said heat pump with electricity coming from outside the facility,
using resulting product coming from said fuel cell,
using resulting product coming from outside the facility,
powering said fuel cell with electricity from outside the facility so that it operates in electrolysis mode and generates fuel and oxidizer,
using directly the fuel and/or oxidizer and/or resulting product or storing it for future use.

9. The method according to claim 8, wherein the fuel cell generating electricity uses dihydrogen as reducing fuel and the reaction taking place in the chemical reactor is a process of thermal dissociation of water using the sulfur iodine cycle in which the following chemical reactions are carried out:
2H₂SO₄→2SO₂+2H₂O+O₂
2HI→I₂+H₂
I₂+SO₂+2H₂O→2HI+H₂SO₄

10. The method according to claim 8, wherein the fuel cell generating electricity uses dihydrogen as reducing fuel and the reaction taking place in the chemical reactor is a process of thermal dissociation of water using the bromine cycle in which the following reactions are used:
2H₂SO₄→2SO₂+2H₂O+O₂
2HBr→Br₂+H₂
Br₂+SO₂+2H₂O→2HBr+H₂SO₄

11. The method according to claim 8, wherein the fuel cell generating electricity uses dihydrogen as reducing fuel and the reaction taking place in the chemical reactor is a process of thermal dissociation of water using an alkali metal hydride in which water mixed with the alkali metal reacts to form an alkali metal hydride and dioxygen (H₂O+2 Me->2MeH+½O₂) while the alkali metal hydride is transformed in another reactor into metal and dihydrogen (2MeH->2Me+H₂).

12. The method according to claim 8, wherein the fuel cell generating electricity uses dihydrogen as reducing fuel and the reaction taking place in the chemical reactor is a process of thermal dissociation of water using Iron III chloride and Iron II chloride (6FeCl₂+8H₂O->2Fe₃O₄+12HCl+2H₂; 2Fe₃O₄+12HCl+3Cl₂->6FeCl₃+6H₂O+O₂ and 6FeCl₃->6FeCl₂+3Cl₂).

13. The method according to claim 8, wherein the fuel cell generating electricity uses dihydrogen as reducing fuel and the reaction taking place in the chemical reactor is a process of thermal dissociation of water using vanadium chloride and vanadium tetrachloride (Cl₂+H₂O->2HCl+½O₂; 2HCl+2VCl₂->2VCl₃+H₂; 2VCl₃->VCl₂+VCl₄; 2VCl₄->2VCl₃+Cl₂).

14. The method according to claim 8, wherein methane reacts in a first compartment with water to form dihydrogen and carbon monoxide (CH₄+H₂O->CO+3H₂), carbon monoxide and dihydrogen react in a second compartment to form methanol (CO+2H₂->CH₃OH), methanol reacts in a third compartment with arsenate to form arsenious anhydride and dioxygen (CH₃OH+As₂O₄->CH₄+As₂O₅), a fourth and a fifth compartment allowing the formation of arsenate and dioxygen from arsenious anhydride (½As₂O₅->½As₂O₃+½O₂ and ½As₂O₅+½As₂O₃->As₂O₄).

15. The method according to claim 8, wherein the fuel cell generating electricity uses methanol as fuel.

16. The method according to claim 8, wherein the fuel cell generating electricity uses dihydrogen as reducing fuel and the reaction taking place in the chemical reactor is a process of thermal dissociation of water using copper and chlorine.

17. The method according to claim 8, wherein the fuel cell generating electricity uses dihydrogen as reducing fuel and wherein the excess hydrogen is used to generate ammonia.

18. The method according to claim 8, wherein the fuel cell generating electricity uses dihydrogen as reducing fuel and wherein the excess hydrogen is used to generate urea.
